(19) United States
(12) Patent Application Publication
(10) Pub. No.: US 2026/0070328 A1
(43) Pub. Date: Mar. 12, 2026

(54) PRINTING APPARATUS, CONTROL METHOD, AND STORAGE MEDIUM

(71) Applicant: CANON KABUSHIKI KAISHA, Tokyo (JP)

(72) Inventors: YUMIKA NAKAMURA, Tokyo (JP); YUSUKE MATSUDO, Kanagawa (JP); SHUMA HASHIMOTO, Tokyo (JP)

(21) Appl. No.: 19/311,378

(22) Filed: Aug. 27, 2025

(30) Foreign Application Priority Data
Sep. 10, 2024 (JP) 2024-156738

(51) Int. Cl. B41J 2/045; B41J 2/14

(52) U.S. Cl. CPC B41J 2/0451; B41J 2/04538; B41J 2/04565; B41J 2/0457; B41J 2/04573; B41J 2/0459; B41J 2/04591; B41J 2/14072; B41J 2/0458

(57) ABSTRACT

A technique by which deterioration of a heat resistor can be detected more accurately is provided. There are included a printing head configured to eject an ink from a nozzle provided so that the nozzle corresponds to a heat resistor and perform printing by applying a pulse voltage to the heat resistor; an obtaining unit configured to obtain a prediction resistance value of the heat resistor according to a unique value of the heat resistor and a setting value to drive the heat resistor; a measurement unit configured to measure the resistance value of the heat resistor; and a determination unit configured to determine based on the prediction resistance value and the resistance value whether deterioration arises in the heat resistor.

### BACKGROUND

### Field of the Technology

The present disclosure relates to a printing apparatus, a control method, and a storage medium.

### Description of the Related Art

A printing head performing printing by ejecting an ink from a plurality of nozzles by using an inkjet system is configured to eject the ink from the nozzles by applying energy to a heating resistor provided so that the heating resistor corresponds to each nozzle and film-boiling the ink near the heating resistor. Hereinafter, the energy applied to the heating resistor to eject the ink from the nozzles is referred to as “ejection energy.”

The ejection energy actually consumed in each heating resistor inversely varies with the resistance value of the heating resistor in a case where a head voltage and a pulse width are constant. Incidentally, the resistance value varies from one heating resistor to another because of manufacturing processes for the heat resistor and the aging of the heat resistor in use circumstances, or the like. Thus, ejection energy which is actually consumed by each heating resistor varies from one heat resistor to another. Japanese Patent Laid-Open No. 2013-082080 discloses a technique of measuring the resistance value of a heat resistor and detecting the deterioration of the heat resistor based on the measured resistance value.

However, in the technique disclosed in Japanese Patent Laid-Open No. 2013-082080, the variation in resistance values during manufacturing processes for the heat resistor is not considered. Thus, in the technique disclosed in Japanese Patent Laid-Open No. 2013-082080, it is impossible to accurately detect the deterioration of the heat resistor, and the deterioration of the heat resistor may fail to be detected before the heat resistor stops functioning.

### SUMMARY

The present disclosure is made in the light of the above problem and provides a technique of allowing the deterioration of the heat resistor to be more accurately detected.

A printing apparatus according to some embodiments includes a printing head configured to eject an ink from a nozzle provided so that the nozzle corresponds to a heat resistor and perform printing by applying a pulse voltage to the heat resistor; an obtaining unit configured to obtain a prediction resistance value of the heat resistor according to a unique value of the heat resistor and a setting value to drive the heat resistor; a measurement unit configured to measure a resistance value of the heat resistor; and a determination unit configured to determine based on the prediction resistance value and the resistance value whether deterioration arises in the heat resistor.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of a printing apparatus;

FIG. 2 is a schematic diagram of an element substrate;

FIG. 3A and FIG. 3B are schematic configuration diagrams of the vicinity of a nozzle;

FIG. 4 is a diagram illustrating a change in the resistance value of a heat resistor according to the number of pulses;

FIG. 5 is a diagram illustrating a change in the resistance value caused by manufacturing dispersion or errors in the heat resistor;

FIG. 6 is a diagram illustrating a change in the resistance value caused by the driving setting values of a printing head;

FIG. 7 is a diagrammatic illustration illustrating a change in the resistance value of the heat resistor;

FIG. 8 is a block diagram illustrating the configuration of a control system of a printing apparatus;

FIG. 9 is a flow chart illustrating the details of processing in a determination process;

FIG. 10 is a block diagram illustrating the configuration of a control system of a printing apparatus according to another embodiment;

FIG. 11 is a flow chart illustrating the details of processing in an adjustment process;

FIG. 12 is a flow chart illustrating the details of processing in a determination process according to another embodiment; and

FIG. 13 is a graph illustrating the relation between a change curve of the actual value of a resistance value and a change curve of a prediction resistance value.

### DESCRIPTION OF THE EMBODIMENTS

Examples of embodiments of a printing apparatus, a control method, and a storage medium are described below in detail with reference to the attached drawings. The following embodiments do not limit the present disclosure, and not all combinations of features described in the present embodiments are essential for a solution of the present disclosure. Further, the positions and the shapes or the like of constituent elements described in the embodiments are only examples, and the embodiments do not purport to limit the scope of the present disclosure to the positions and the shapes or the like of constituent elements.

### First Embodiment

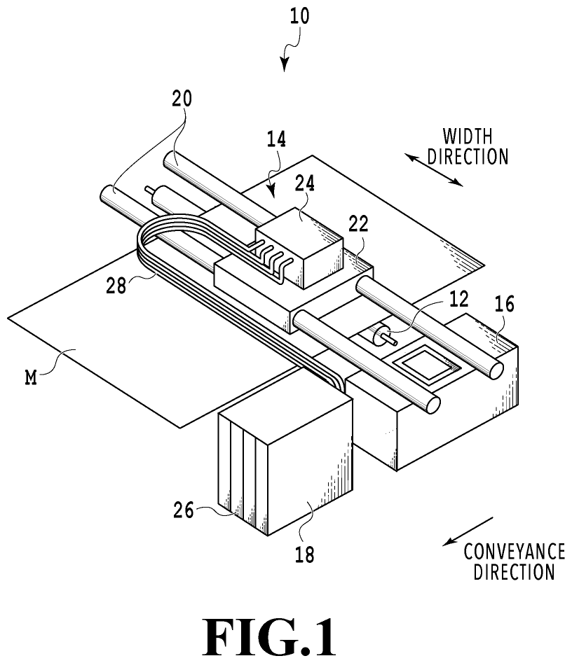

First, with reference to FIGS. 1 to 9, a printing apparatus according to the present embodiment is described.

### <Schematic Configuration of Printing Apparatus>

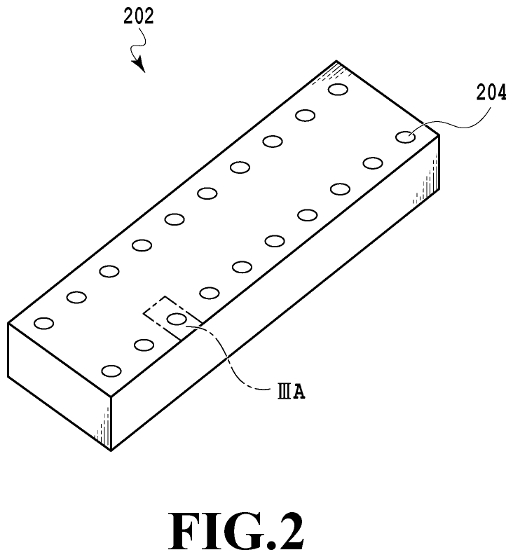

FIG. 1 is a schematic configuration diagram of a printing apparatus according to the present embodiment. FIG. 2 is a schematic diagram of an element substrate provided in a printing head. A printing apparatus 10 in FIG. 1 includes a conveyance part conveying a printing medium M and a printing part 14 performing printing by ejecting an ink to the printing medium M conveyed by the conveyance part 12. Further, the printing apparatus 10 includes a recovery part 16 to maintain and recover performance on ink ejection from a printing head 24 (described later) in the printing part 14 and an accommodation part 18 accommodating an ink tank storing an ink to be supplied to the printing head 24.

The printing part 14 includes a carriage 22 slidably provided in a guide rail 20 extending in a width direction of a printing medium intersecting with (in the present embodiment, orthogonal to) a conveyance direction in which the printing medium is conveyed by the conveyance part 12 (see FIG. 1). The carriage 22 is configured to be reciprocally movable along the guide rail 20 in the width direction by driving force of a driving part (not illustrated).

Further, the printing part 14 includes the printing head 24 mounted on the carriage 22 and ejecting the ink to the printing medium M. Accordingly, the printing head 24 is reciprocally movable in the width direction via the carriage 22. The printing head 24 is configured to be capable of ejecting one or more inks and, a plurality of nozzles 204 (described later) capable of ejecting the ink are formed in a plane (hereinafter also referred to as “nozzle plane”) opposite to the printing medium M conveyed by the conveyance part 12. Specifically, in the printing head 24, one or more element substrates 202 (see FIG. 2) in which the plurality of nozzles 204 are formed are arranged on the nozzle plane.

In the element substrate 202, the plurality of nozzles 204 are arranged at regular intervals in a predetermined direction. In the present embodiment, the plurality of nozzles 204 are arranged and two nozzle arrays are formed in the element substrate 202. The element substrate 202 is arranged so that the nozzle arrays extend on the nozzle plane of the printing head 24 in a direction intersecting with the width direction which is a moving direction of the printing head 24.

The printing apparatus 10 performs a printing operation in which the ink is ejected to the printing medium M conveyed to a printing start position by the conveyance part 12 while the printing head 24 is moved in the width direction. Next, the conveyance part 12 performs a conveyance operation in which the printing medium M is moved by a predetermined amount in the conveyance direction, and then a printing operation in which the ink is ejected while the printing head 24 is moved in the width direction is performed again. In this way, the printing apparatus 10 performs printing on the printing medium M by repeatedly performing the printing operation and the conveyance operation by turns.

The recovery part 16 is provided in a position where various types of recovery operations to maintain and recover the performance on the ink ejection can be performed with respect to the printing head 24 positioned in a stand-by position. Incidentally, the stand-by position is a position where the printing head 24 is positioned in a case where no printing is performed. Further, the accommodation part 18 accommodates ink tanks 26 storing inks to be ejected from the printing head 24. In a case where a cyan (C) ink, a magenta (M) ink, a yellow (Y) ink, and a black (Bk) ink are ejected in the printing head 24, the ink tanks 26 storing the respective inks are individually accommodated in the accommodation part 18. In the ink tanks 26 accommodated in the accommodation part 18, each of the stored inks is supplied to the printing head 24 via a tube 28. Incidentally, the ink ejected from the printing head 24 is not limited to an ink containing color material but includes a process liquid applying a predetermined process to the ink ejected on the printing medium M.

### <Configuration of Element Substrate>

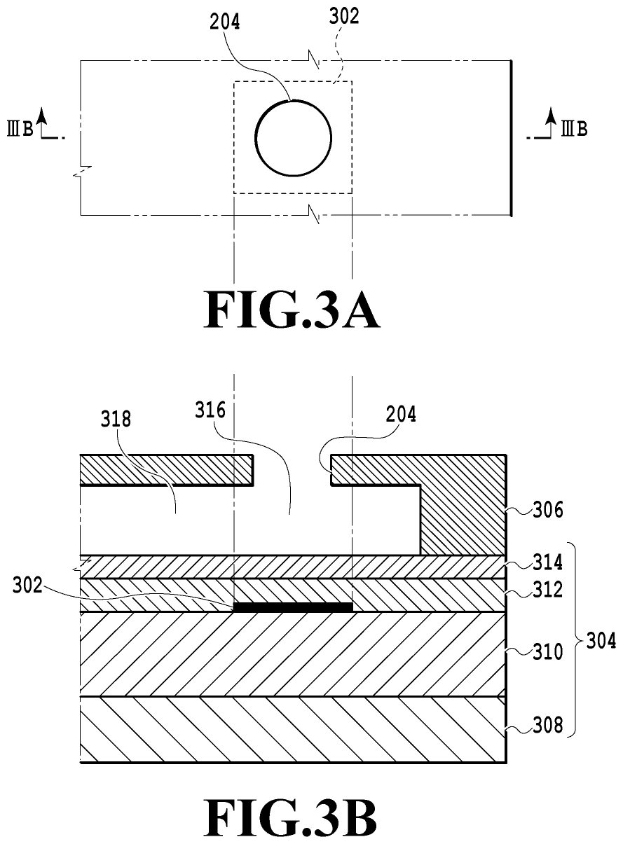

Next, the configuration of the element substrate 202 is described. FIGS. 3A and 3B are schematic configuration diagrams of the element substrate 202, FIG. 3A is an enlarged view of a frame IIIA of FIG. 2, and FIG. 3B is a cross-sectional view taken along line IIIB-IIIB of FIG. 3A.

The element substrate 202 includes a substrate 304 including a heat resistor 302 generating heat energy to be used for the ejection of the ink and a nozzle forming member 306 provided on the substrate 304. The substrate 304 includes a semiconductor substrate 308, a heat accumulation layer 310, the heat resistor 302, a protective layer 312, and an anti-cavitation layer 314.

The substrate 304 is created by, for example, the following procedure. First, the semiconductor substrate 308 is formed by using single crystal silicon. Next, the heat accumulation layer 310 which is 300 nm in thickness is formed on the semiconductor substrate 308 by using silicon oxide. Then, the heat resistor 302 which is W×L=26 μm×26 μm in size is formed on the heat accumulation layer 310 by using tantalum silicon nitride (Ta 61% and Si 39%). The heat resistor 302 is in the shape of a rectangle, and in the size, W is the length of one predetermined side, and L is the length of one side adjacent to the predetermined side. Further, the protective layer 312 which is 300 nm in thickness is formed by using silicon nitride in such a way as to cover the heat resistor 302 on the heat accumulation layer 310. Further, the anti-cavitation layer 314 which is 230 nm in thickness is formed on the protective layer 312 by using tantalum.

The nozzle forming member 306 is formed on the anti-cavitation layer 314 in the substrate 304. Further, a pressure chamber 316 storing the ink to be ejected from the nozzle 204 and a flow path 318 communicating with and guiding the ink to the pressure chamber 316 are formed by the substrate 304 and the nozzle forming member 306.

In the element substrate 202, in a case where a predetermined voltage is applied to the heat resistor 302 via wiring (not illustrated), the heat energy is generated in the heat resistor 302, and the generated heat energy causes air bubbles in the pressure chamber 316 in which the ink is stored. Further, a pressure in the pressure chamber 316 increases because of the generated air bubbles, and the ink in the pressure chamber 316 is ejected from the nozzle 204.

In this way, in a case where the ink is ejected from the nozzle 204, ejection energy is applied to the heat resistor 302. In the present embodiment, a pulse voltage is applied to the heat resistor 302. Further, in a case where the ink is ejected from the nozzle 204, the disappearance of the generated air bubbles puts a load of about 100 atmospheric pressures on the anti-cavitation layer 314 and the protective layer 312. Thus, in a case where the ejection of the ink from the nozzle 204 is repeated, the anti-cavitation layer 314 and the protective layer 312 are worn and the heat resistor 302 is damaged. Furthermore, in a case where the ejection is further repeated, the resistance value of the heat resistor 302 gradually rises and the deterioration of the heat resistor progresses, and a wire break occurs in the heat resistor 302, defective ink ejection arises in the nozzle 204 corresponding to the heat resistor 302 in the end.

### <Change in Resistance Value of Heat Resistor>

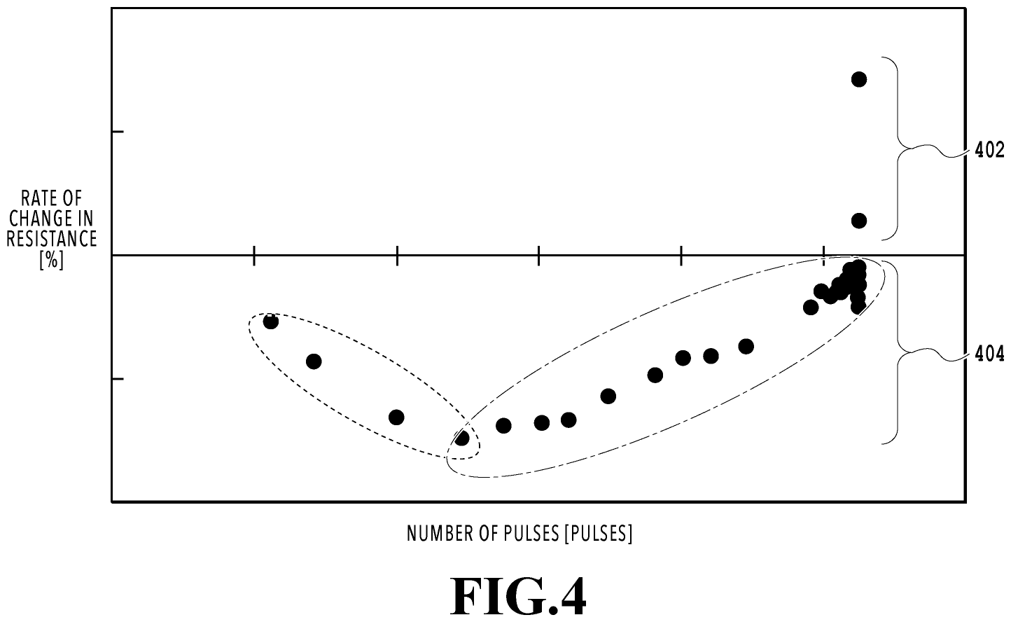

Next, a description is made about a change in the resistance value of the heat resistor because of the ejection of the ink. FIG. 4 is a diagram illustrating a change in the resistance value of the heat resistor with respect to the number of pulses. In FIG. 4, the horizontal axis represents the number of pulses (pulses), and the vertical axis represents the rate of change in resistance (%) as a change in the resistance value of the heat resistor. The rate of change in resistance is set at the ratio of the difference between a resistance value Rn in a case of the number of pulses n and an initial resistance value R₀ with respect to the initial resistance value R₀, that is, (Rn−R₀)/R₀.

In regard to the resistance value of the heat resistor 302, a sharp rise 402 in the resistance value occurs before the wire break in a case where the deterioration of the heat resistor 302 progresses because of an increase in the number of pulses. In contrast, before the wire break, a change 404 arises in the resistance value of the heat resistor 302 according to the change in the number of pulses. This is because oxidization and crystallization are caused by repeatedly driving the heat resistor 302. In the resistance value of the heat resistor 302, a decrease (a portion circled by dashed lines) in the resistance value caused by crystallization is dominant in an area where the number of pulses is small, and in a case where the number of pulses is greater than or equal to the predetermined number of pulses, a rise (a portion circled by dot-dash lines) in the resistance value caused by oxidization is dominant in an area where the number of pulses is large.

Here, in regard to the resistance value of the heat resistor 302, it is understood that the behavior of the change in the resistance value of the heat resistor 302 varies according to variation (hereinafter referred to as “manufacturing dispersion or errors” as appropriate) caused in manufacturing processes for the heat resistor 302 and the driving setting values of the printing head 24. In the present embodiment, in order to determine the change in the resistance value caused by the deterioration of the heat resistor 302 with accuracy, the change 404 (see FIG. 4) in the resistance value of the heat resistor 302 is used.

<Overview of determination of deterioration of heat resistor>

In the present embodiment, the deterioration of the heat resistor 302 is determined by the following procedure. Incidentally, in the present embodiment, as the deterioration of the heat resistor 302, the heat resistor 302 stopping functioning, that is, being in a state where defective ink ejection may occur in the corresponding nozzle is determined as the heat resistor 302 being deteriorated. Incidentally, the defective ink ejection includes, for example, ink non-ejection in which the ink is not ejected.
(1) Calculate the prediction resistance value of the heat resistor 302 by using a calculation formula for calculating a resistance change in the heat resistor 302;
(2) Measure the resistance value of the heat resistor 302; and
(3) Compare the prediction resistance value of the heat resistor 302 with the measured resistance value of the heat resistor 302.

### <Calculation Formula>

First, an explanation is made about the calculation formula for calculating the resistance change in the heat resistor 302. In consideration of the behavior of the change in the resistance value of the heat resistor 302 caused according to the manufacturing dispersion or errors in the heat resistor 302 and the driving setting values of the printing head 24, resistance values for a plurality of samples according to the number of pulses are measured in order to formulate the change in the resistance value of the heat resistor. In more detail, used samples were samples in which ranges within which the manufacturing dispersion or errors in the heat resistor 302 and the driving setting values of the printing head 24 can respectively fall were assumed. Measurement data was obtained by using these samples and performing a durability test in which a resistance change with respect to the number of pulses was measured.

### =Resistance Value Change Caused by Manufacturing Dispersion or Errors in Heat Resistor=

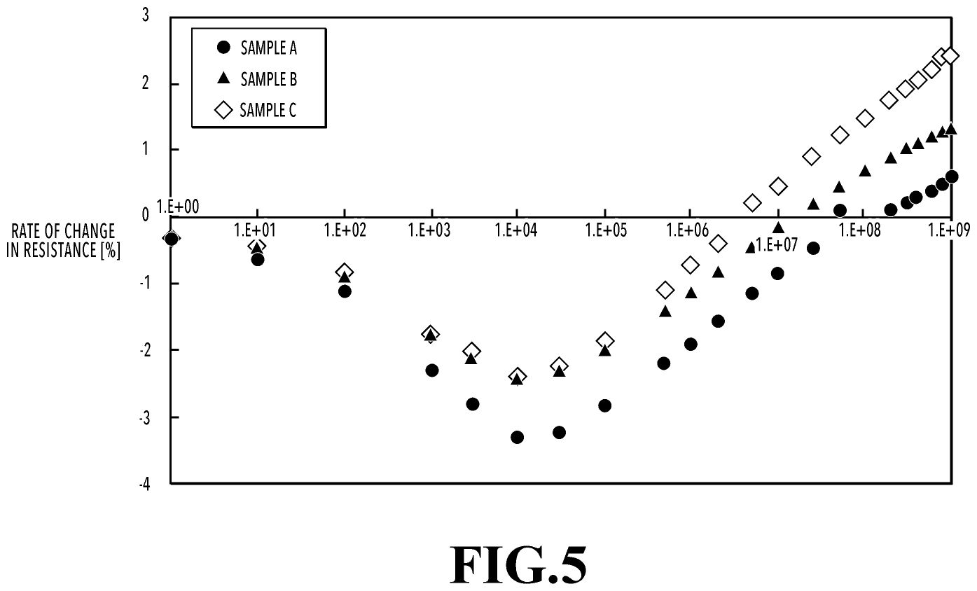

First, the change in the resistance value caused by the manufacturing dispersion or errors in the heat resistor 302 is verified. FIG. 5 is a diagram illustrating resistance value changes caused by the manufacturing dispersion or errors in the heat resistor 302 obtained from results of the durability test. In the verification, in order to measure the changes in the resistance value caused by the manufacturing dispersion or errors in the heat resistor 302, three samples whose specific resistances p and film thicknesses T of the heat resistor 302 were different were used.

Specifically, the used three samples were as follows: A sample A with a specific resistance ρ of 1000 μΩ·cm and a film thickness T of 13.3 nm, a sample B with a specific resistance ρ of 700 μΩ·cm and film thickness T: 9.3 nm, and a sample C with a specific resistance ρ of 700 μΩ·cm and a film thickness T of 7.0 nm. Further, the driving setting values of the printing head 24 in the durability test were under the same conditions in each sample. Specifically, electric power equivalent to the number of pulses Pc of 1.0×10¹⁰ was supplied to the element substrate 202 in a case of a pulse width Pw of 1.0 μs over a pulse period of 15 kHz at a head voltage (voltage value) V of 32.28 V.

The results of the durability test performed on the three samples on the above conditions are shown in FIG. 5. It is found from the results that the changes in resistance values are different because of the differences in the specific resistance ρ and the film thickness T in which the manufacturing dispersion or errors in the heat resistor 302 was assumed. Compared with the sample B and the sample C whose specific resistances p are low, the sample A whose specific resistance ρ was high remarkably exhibited an effect on descending components of the resistance value change, and the minimum value of the resistance value change (rate of change in resistance) was the lowest. Further, compared with the sample A and the sample B whose film thicknesses T were larger, the sample C whose film thickness T was small exhibited an effect on ascending components of the resistance value change, and a resistance value in a case of the same number of pulses was high.

### =Resistance Value Change Caused by Driving Setting Values of Printing Head 24=

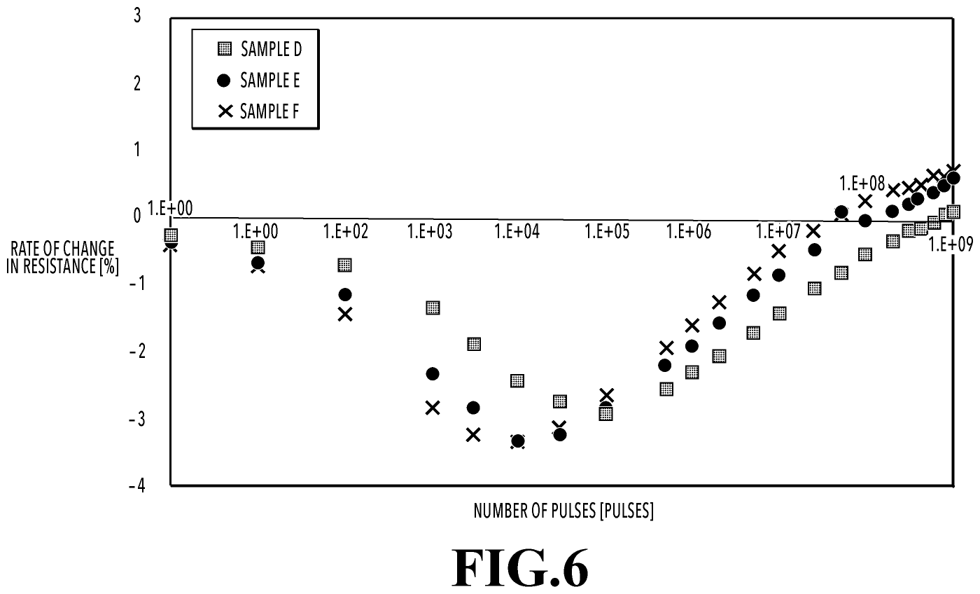

Next, changes in the resistance value caused by the driving setting values of the printing head 24 are verified. FIG. 6 is a diagram illustrating resistance value changes caused by the driving setting values of the printing head 24 obtained from the results of the durability test. In the verification, in order to measure changes in the resistance value of the heat resistor 302 caused by differences in the driving setting values of the printing head 24, three samples which were different in the head voltage V which was one of the driving setting values were used to measure the changes in the resistance values of the heat resistors 302 having the same configuration.

Specifically, the used three samples were a sample D with a head voltage V of 30.70 V, a sample E with a head voltage V of 32.28 V, and a sample F with a head voltage V of 33.06 V. Further, other driving setting values include a pulse width Pw of 1.0 μs and a pulse period of 15 kHz, and electrical power equivalent to the number of pulses Pc of 1.0×10¹⁰ was supplied to the element substrate 202. Furthermore, heat resistors 302 used for all the samples were heat resistors 302 with a specific resistance ρ of 1000 μΩ·cm and a film thickness T of 13.3 nm.

The results of the durability test performed on the three samples on the above conditions are shown in FIG. 6. It is found from the results that the differences in the change in the resistance values of the heat resistors 302 arise because of the difference in the head voltage V of the driving setting values. Compared with the samples D and E whose head voltages V are low, ejection energy per pulse increases in the sample F whose head voltage V is high, and thus horizontal axis components are influenced, and a change according to the number of pulses Pc is quickly exhibited.

=Formulation=

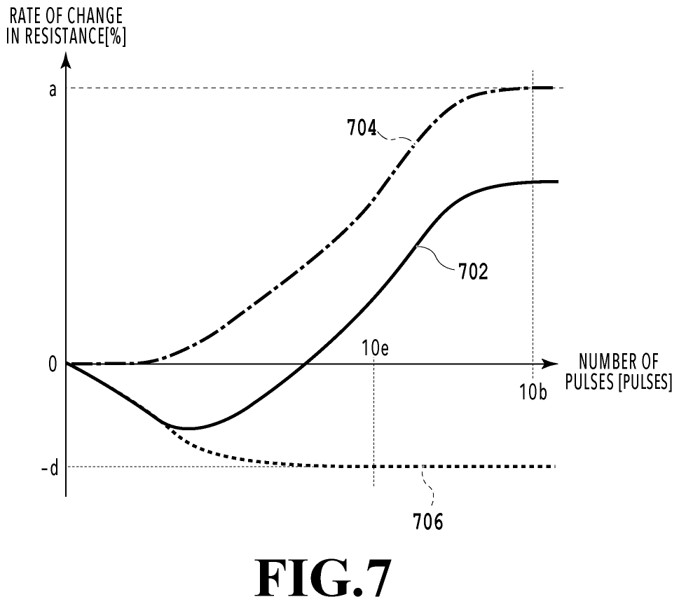

From the above results of the durability test, the formulation of the resistance value change in the heat resistor 302 is performed for manufacturing dispersion or errors in the heat resistor 302 and the driving setting values of the driving head 24 which can change in each nozzle 204. FIG. 7 is a diagrammatic illustration expressing the resistance value change of the heat resistor 302.

As shown in FIG. 7, in a resistance value change in a simulative heat resistor 302, a resistance change combined component 702 which is the resistance value change in the heat resistor 302 is the sum of an ascending component 704 of the resistance value change caused by oxidization and a descending component 706 of the resistance value change caused by crystallization. The rate of change in resistance from an initial resistance value is represented by the following formula (1) based on the resistance change combined component 702.

$$\frac{Δ R}{{R}_{0}} = a ( 1 - exp ( - {P}_{c}^{\frac{1}{b}} ) ) - d ( 1 - exp ( - {P}_{c}^{\frac{1}{e}} ) ) \qquad ( 1 )$$

The formula (1) mentioned above indicates that the descending component and the ascending component start changing at the same time as the application of a pulse and the changes converge in a case where the predetermined number of pulses Pc is reached. In the formula (1) mentioned above, ΔR/R₀ is the rate of change in resistance, Pc is the number of pulses, variables a, b, d, and e are variables relating to the configuration of the substrate 304. ΔR is the difference between a resistance value in a case of the number of pulses n and an initial resistance value. Further, the variable a is the convergence value of the rate of change in resistance of the ascending component 704 of the resistance value change, and the variable d indicates the convergence value of the rate of change in resistance of the descending component 706 of the resistance value change (see FIG. 7). Further, the variable b denotes a variable such that the number of pulses in a case of the convergence of the rate of change in resistance of the ascending component 704 of the resistance value change is 10b, and the variable e denotes a variable such that the number of pulses in a case of the convergence of the resistance change of the descending component 706 of the resistance value change is 10e (see FIG. 7).

As mentioned above, the variables a, b, d, and e are variables relating to the configuration of the substrate 304 and are variables changing according to manufacturing dispersion or errors in the heat resistor 302 and the driving setting values of the printing head 24. Further, the variables a, b, d, and e can be obtained by performing curve fitting (regression analysis) of measured data on a function (nonlinear model) in the formula (1) mentioned above. The obtained variables a, b, d, and e are expressed in the following formula (2).

$$a = D ρ + {( \frac{A}{T} )}^{N} , b = - {B}_{1} J + {B}_{2} , d = D ρ , e = - {E}_{1} J + {E}_{2} \qquad ( 2 )$$

In the formula (2) mentioned above, constants A, B1, B2, D, E1, E2, and N are constants which do not depend on the manufacturing dispersion or errors in the heat resistor 302 and the driving setting values of the printing head 24. Further, in the formula (2) mentioned above, p is the specific resistance of the heat resistor 302, T is the film thickness of the heat resistor 302, and J is ejection energy per pulse consumed by the heat resistor 302. The specific resistance p, the film thickness T, and the ejection energy J are values changing according to the manufacturing dispersion or errors in the heat resistor 302 and the driving setting values of the printing head 24. A general formula for the ejection energy J can be expressed by the following formula (3).

J=V²Rw/R. . . (3)

In the formula (3) mentioned above, V is the head voltage, R is the resistance value of the heat resistor 302, and Pw is the pulse width. In the present embodiment, the pulse width Pw is constant, and the head voltage V is determined by the driving setting values of the printing head 24. Further, in the formula (3) mentioned above, the resistance value R of the heat resistor 302 changes according to the number of pulses Pc, but for the sake of the simplification of calculation, the initial resistance value R₀ is used.

Further, as mentioned above, in the specific resistance ρ and the film thickness T, manufacturing dispersion or errors in each heat resistor 302 arises, but there are no procedures for directly measuring the manufacturing dispersion or errors in each heat resistor 302, and variation in a case of manufacturing a heater board in the same printing head 24 is much greater in the specific resistance ρ than in the film thickness T due to a construction method. Thus, in the present embodiment, the film thickness T of the heat resistor 302 is constant, and variation of the specific resistance ρ is calculated from the actual value of resistance. A general formula for the specific resistance ρ is expressed by the following formula (4).

p=RTW/L. . . (4)

In the formula (4) mentioned above, R is the resistance value of the heat resistor 302, T is the film thickness of the heat resistor 302, W is the length of a predetermined one side of the heat resistor 302, and L is the length of one side adjacent to the predetermined one side of the heat resistor 302. Hereinafter, W and L are collectively referred to as the size of the heat resistor 302 as appropriate. In the present embodiment, the film thickness T and the size (W, L) of the heat resistor 302 are constant. Further, the resistance value R of the heat resistor 302 changes according to the number of pulses Pc, but for the sake of the simplification of calculation, the initial resistance value R₀ is used. The specific resistance ρ is thereby calculated.

The formula (1) mentioned above is converted by using the formula (2), the formula (3), and the formula (4) mentioned above, and then the following formula (5) is obtained.

$$\frac{Δ R}{{R}_{0}} = ( \frac{{DR}_{0} TW}{L} + {( \frac{A}{T} )}^{N} ) ( 1 - exp ( - {P}_{c}^{\frac{1}{- \frac{{B}_{1} {V}^{2} {P}_{w}}{{R}_{0}} + {B}_{2}}} ) ) - \frac{{DR}_{0} TW}{L} ( 1 - exp ( - {P}_{c}^{\frac{1}{- \frac{{E}_{1} {V}^{2} {P}_{w}}{{R}_{0}} + {E}_{2}}} ) ) \qquad ( 5 )$$

The prediction resistance value of the heat resistor 302 in the predetermined number of pulses Pc can be obtained by substituting the film thickness T, size (W, L), initial resistance value R₀, head voltage V, pulse width Pw, and the number of pulses Pc of the heat resistor 302 into the formula (5) mentioned above. In other words, the resistance value R obtained by the formula (5) is obtained as the prediction resistance value. The formula (5) is, for example, stored in a storage area of the printing apparatus 10 and is to be used in a case of the detection of the deterioration of the heat resistor 302 or the like.

### <Determination of Deterioration of Heat Resistor>

Next, an explanation is made about the determination of the deterioration of the heat resistor 302. In the determination of the deterioration of the heat resistor 302, as mentioned above, first, the manufacturing dispersion or errors in the heat resistor 302 and the driving setting values of the printing head 24 are substituted into the formula (5) described above to calculate a prediction resistance value (equivalent to [1] in the overview). Then, the resistance value of each heat resistor 302 is measured by using a control circuit and a measurement circuit provided in the printing apparatus 10 (equivalent to [2] in the overview). Subsequently, the calculated prediction resistance value and the measured resistance value are compared, and in a case where the difference between the calculated prediction resistance value and the measured resistance value is higher than a threshold value, it is determined that a change in the resistance value is deviated and that the corresponding heat resistor 302 is deteriorated and may not function. Hereinafter, determination of deterioration of the heat resistor 302 is described in detail.

### =Configuration of Control System of Printing Apparatus=

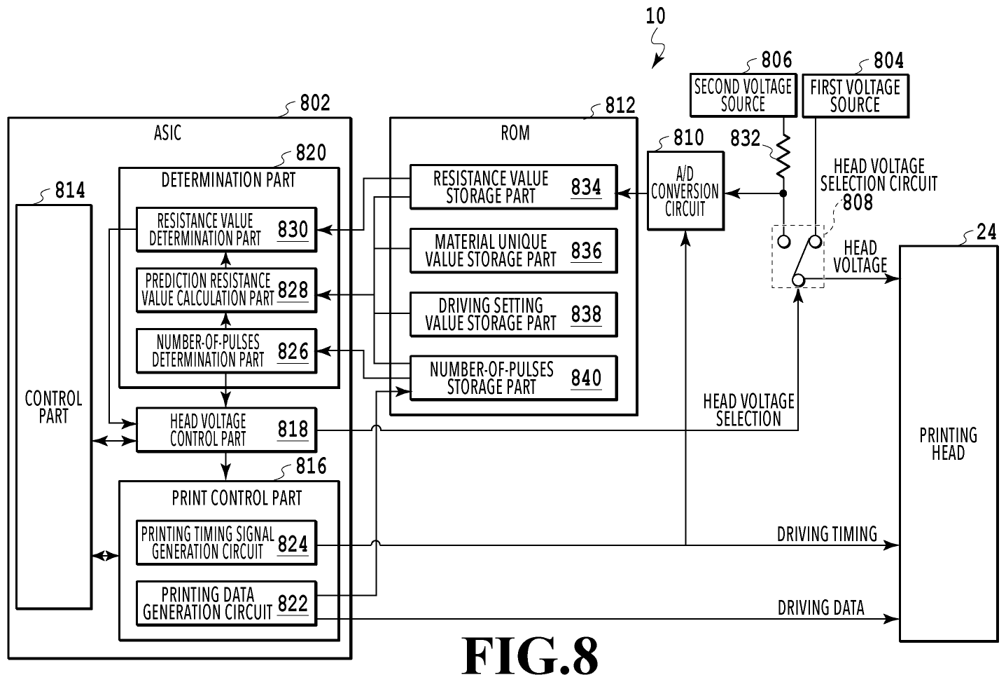

First, the configuration of a control system of the printing apparatus 10 is described. FIG. 8 is a block diagram illustrating the configuration of the control system of the printing apparatus 10. The printing apparatus 10 includes an ASIC 802, a first voltage source 804, a second voltage source 806, a head voltage selection circuit 808, an analog to digital (A/D) conversion circuit 810, and a ROM 812.

The ASIC 802 includes a control part 814 controlling the entire operations of the printing apparatus 10, a print control part 816 outputting a control signal to the printing head 24, and a head voltage control part 818 controlling the head voltage V, and a determination part 820 determining the deterioration of the heat resistor 302.

The control part 814 controls the entire operations of the printing apparatus 10 in addition to the print control part 816, the head voltage control part 818, and the determination part 820 while mutually communicating with a plurality of functional blocks such as an external communication part though its illustration is omitted.

The print control part 816 includes a print data generation circuit 822 generating driving data to drive the printing head 24 and a print timing signal generating circuit 824 generating a driving timing signal providing a timing of the ejection of an ink to the printing head 24. The print data generation circuit 822 generates driving data to eject the ink from the printing head 24 based on image data input to the printing apparatus 10 and transmits the generated driving data to the printing head 24. Further, a driving data signal generated in the print data generation circuit 822 is also transmitted to a number-of-pulses storage part 840 (described later).

The print timing signal generating circuit 824 generates a driving timing signal providing a timing at which the printing head 24 ejects the ink and transmits the generated driving timing signal to the printing head 24. Further, the driving timing signal generated in the print timing signal generating circuit 824 is also transmitted to the A/D conversion circuit 810. The printing head 24 ejects the ink by selectively feeding electricity to each heat resistor 302 based on the driving data and the driving timing transmitted from the print control part 816.

The head voltage control part 818 transmits a switching signal to switch the head voltage V of the head voltage selection circuit 808 based on a signal received from the number-of-pulses determination part 826 (described later). Further, simultaneously with the switching signal, the head voltage control part 818 transmits a signal to control data transmitted from the print control part 816 in such a way that a current is fed to only one heat resistor 302.

The determination part 820 includes the number-of-pulses determination part 826, a prediction resistance value calculation part 828, and a resistance value determination part 830. The number-of-pulses determination part 826 determines a timing at which the resistance value of the heat resistor 302 is read from the value of the number of pulses stored in the number-of-pulses storage part 840 and transmits a signal to cause the head voltage control part 818 to output the switching signal. Further, the number-of-pulses determination part 826 transmits a signal to start calculation to the prediction resistance value calculation part 828. The prediction resistance value calculation part 828 calculates the prediction resistance value of the heat resistor 302 from the formula (5) mentioned above by using the initial resistance value R₀ stored in the ROM 812, and the thickness T, the size (W, L), the head voltage V, the pulse width Pw, and the number of pulses Pc of the heat resistor 302.

In a case of the predetermined number of pulses applied to a predetermined heat resistor 302, the resistance value determination part 830 compares a prediction resistance value calculated by the prediction resistance value calculation part 828 to the measured resistance value of the predetermined heat resistor 302 stored in a resistance value storage part 834 (described later) and determines whether the heat resistor 302 is deteriorated based on a difference between the prediction resistance value and the measured resistance value. The resistance value determination part 830 outputs a signal to prohibit the application of the head voltage V to the head voltage control part 818 in a case where the resistance value determination part 830 determines that the heat resistor 302 is deteriorated.

The first voltage source 804 is a voltage source of 32 V and is used as a voltage source in a case where a normal printing operation is performed. The second voltage source 806 is a voltage source of 5 V and is used as a voltage source in a case where the resistance value of the heat resistor 302 corresponding to each nozzle 204 in the printing head 24 is measured. Incidentally, the voltage values in the two voltage sources are examples and may be different values. In other words, the first voltage source is configured to apply a pulse voltage of a predetermined voltage value to the heat resistor 302, and the second voltage source is configured to apply a pulse voltage of a voltage value lower than the predetermined voltage value to the heat resistor 302.

The head voltage selection circuit 808 switches head voltages V by using the signal received from the head voltage control part 818. Specifically, a voltage source to be supplied to the printing head 24 is selected from either the first voltage source 804 or the second voltage source 806. Driving of the first voltage source 804 and driving of the second voltage source 806 are controlled by, for example, the control part 814.

A resistor 832 is provided between the second voltage source 806 and the head voltage selection circuit 808. Assume that, for example, a voltage generated by the second voltage source 806 is applied to the printing head 24 by the head voltage selection circuit 808 and a current is passed through only one heat resistor 302 by using a driving data signal and a driving timing signal transmitted from the print control part 816. In this case, a voltage of a voltage value in a case where 5 V is divided by the resistor 832 and the heat resistor 302 is applied to the A/D conversion circuit 810. The resistance value of the heat resistor 302 is measured thereby.

The conversion of an input analog voltage value into a digital value performed by the A/D conversion circuit 810 is triggered by the driving timing signal transmitted from the print timing signal generating circuit 824. Then, the converted data is stored in the resistance value storage part 834 in the ROM 812 as the measured resistance value of the heat resistor 302.

The ROM 812 includes the resistance value storage part 834, a material unique value storage part 836, a driving setting value storage part 838, and the number-of-pulses storage part 840. Incidentally, the ROM 812 includes a storage area in which a program memory or the like to be executed by the ASIC 802 is stored though its illustration is omitted.

The resistance value storage part 834 stores the measured and obtained resistance value of each heat resistor 302. In other words, in the resistance value storage part 834, in regard to the heat resistors 302 provided so that the heat resistors 302 respectively correspond to the plurality of nozzles 204 in the element substrate 202, a digital value input from the A/D conversion circuit is stored as a measured resistance value. Incidentally, the resistance value to be stored in the resistance value storage part 834 includes the initial resistance value R₀ in each heat resistor 302. In regard to the initial resistance value R₀, for example, a resistance value measured in a case where the printing head 24 is driven for the first time after the replacement of the printing head 24 is stored in the resistance value storage part 834 as the initial resistance value R₀. Incidentally, the initial resistance value R₀ is a resistance value in a case where measurement is made on the heat resistor 302 in a case where the number of pulses is less than 100, for example.

The material unique value storage part 836 is a storage area in which the material unique value of the heat resistor 302 necessary for the calculation of the prediction resistance value is stored. Specifically, the material unique value storage part 836 stores the film thickness T and the size (W, L) of the heat resistor 302. The driving setting value storage part 838 is a storage area in which driving setting values of the printing head 24 necessary for the calculation of the prediction resistance value are stored. Specifically, the driving setting value storage part 838 stores the head voltage V and the pulse width Pw. The number of pulses storage part 840 stores the number of pulses Pc applied to each heat resistor 302 based on data generated by the print data generation circuit 822 of the print control part 816.

### (Determination Process)

In the above configuration, in the printing apparatus 10, at a predetermined timing, a determination process to determine whether the heat resistor 302 is deteriorated to the extent that defective ejection arises is performed. The predetermined timing is, for example, a timing at which a process including an operation to apply a pulse voltage to the heat resistor 302 is performed. Specifically, a printing process to perform printing on the printing medium M based on a printing job, a maintenance process to maintain and recover the performance on the ink ejection from the printing head 24, an aging process for the printing head 24 or the like are included. In the following descriptions, a case where a determination process is performed at a timing at which a printing process is performed is described. In other words, in the printing apparatus 10, the determination process is performed in parallel with the printing process.

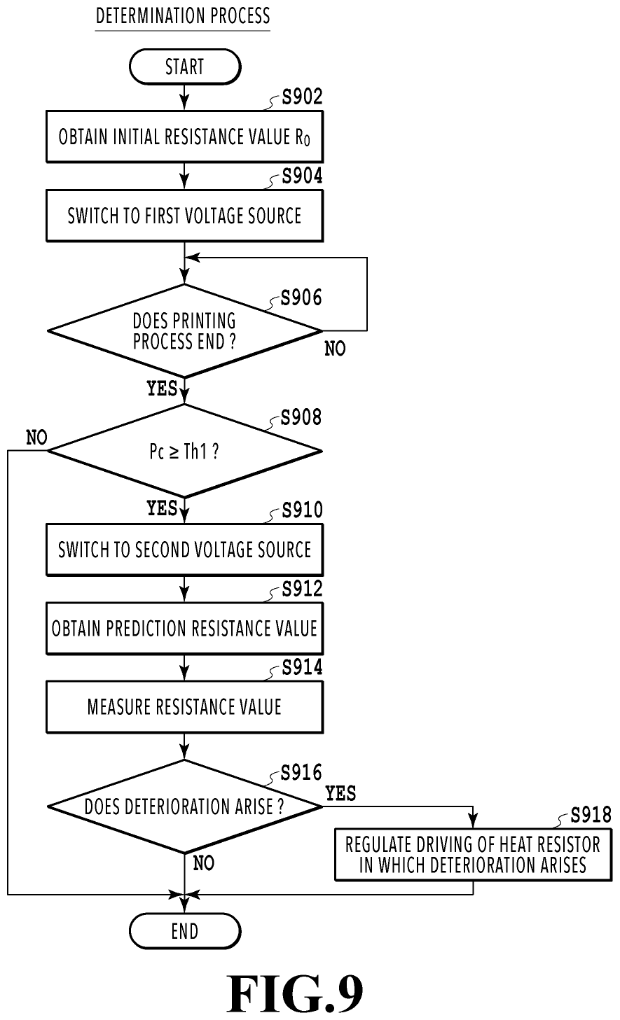

FIG. 9 is a flow chart illustrating the details of processing of the determination process to determine whether the deterioration arises in the heat resistor 302. A series of processes illustrated in the flow chart of FIG. 9 is performed as a result of the ASIC 802 developing, in a RAM (not illustrated), a program code stored in the ROM 812 and executing the program code. Alternatively, the functions of part of or all of the steps in FIG. 9 may be performed by hardware such as other ASICs or electric circuits. In the present specification, a reference sign S in a description of each process in a flow chart refers to a step in the flow chart.

In a case where the determination process starts, first, in S902, the ASIC 802 obtains the initial resistance value R₀. Specifically, in S902, the initial resistance value R₀ of each heat resistor 302 in the resistance value storage part 834 is confirmed, and in a case where the initial resistance value R₀ is stored, the process proceeds to S904, and in a case where the initial resistance value R₀ is not stored, the initial resistance value R₀ is obtained. In a case where the initial resistance value R₀ is obtained, the initial resistance value R₀ in the heat resistor 302 is obtained in a state where the head voltage selection circuit 808 is connected to the second voltage source 806. The obtained initial resistance value R₀ is stored in the resistance value storage part 834 in association with the corresponding heat resistor 302.

Next, in S904, the ASIC 802 controls the head voltage selection circuit 808 and switches a voltage source to supply a voltage to the printing head 24 to the first voltage source 804. Further, in S906, the ASIC 802 determines whether the printing process ends. In the present embodiment, after the end of the process of S904, the printing process starts. In the present embodiment, the ASIC 802 (head voltage control part 818) and the head voltage selection circuit 808 function as connection parts which selectively connect the first voltage source and the second voltage source to the heat resistor 302.

Here, the number of pulses Pc applied to each heat resistor 302 is stored in the number-of-pulses storage part 840. Accordingly, in a case where the printing process starts, the number of pulses Pc stored in the number-of-pulses storage part 840 is obtained, and the obtained number of pulses Pc is counted up in response to printing. Specifically, the number of pulses Pc applied to the heat resistor 302 based on the driving data is added to the stored number of pulses Pc. In a case where the printing process ends, the value of the number of pulses Pc of the heat resistor 302 stored in the number-of-pulses storage part 840 is updated to a calculated count value. In other words, the cumulative number of pulses Pc of each heat resistor 302 is stored in the number-of-pulses storage part 840. Incidentally, the number of pulses Pc applied to each heat resistor 302 stored in the number-of-pulses storage part 840 is initialized in a case of the replacement of the printing head 24, or the like.

In a case where it is determined in S906 that the printing process does not end, the process returns to S906. Further, in a case where it is determined in S906 that the printing process ends, the process proceeds to S908, and the ASIC 802 determines whether the number of pulses Pc applied to the heat resistor 302 reaches a first threshold value Th1. The first threshold value Th1 is, for example, the lower limit value of the number of pulses Pc in which the defective ejection of the ink may caused by the heat resistor 302 in the corresponding nozzle 204 or a value lower than the lower limit value by a predetermined amount. Incidentally, the first threshold value Th1 is experimentally determined according to, for example, material for the heat resistor 302 and the driving setting values.

In a case where it is in S908 determined that the number of pulses Pc does not reach the first threshold value Th1, the determination process ends. Further, in a case where it is determined in S908 that the number of pulses Pc reaches the first threshold value Th1, the process proceeds to S910, and the ASIC 802 controls the head voltage selection circuit 808 and switches a voltage source to supply a voltage to the printing head 24 to the second voltage source 806.

Further, in S912, the ASIC 802 obtains the prediction resistance value of each heat resistor 302. Specifically, in S912, the film thickness T and the size (W, L) of the heat resistor 302 stored in the material unique value storage part 836 are obtained while the initial resistance value R₀ of the heat resistor 302 stored in the resistance value storage part 834 is obtained. Furthermore, in S912, the cumulative number of pulses Pc of the heat resistor 302 stored in the number-of-pulses storage part 840 is obtained while the head voltage V and the pulse width Pw stored in the driving setting value storage part 838 are obtained. Then, in S912, the prediction resistance value is calculated by the formula (5) mentioned above by using these obtained values. In this way, in the present embodiment, the ASIC 802 (prediction resistance value calculation part 828) functions as an obtaining part which obtains the prediction resistance value of the heat resistor 302 according to the unique value of the heat resistor 302 and a setting value to drive the heat resistor 302.

Subsequently, in S914, the ASIC 802 measures the resistance value of each heat resistor 302. Specifically, in S914, the A/D conversion circuit 810 converts a voltage value in a case where a voltage of 5 V of the second voltage source 806 is divided by the resistor 832 and the heat resistor 302, and the resistance value of the heat resistor 302 in a case where the printing process ends is measured. In this way, in the present embodiment, the ASIC 802 (control part 814) functions as a measurement part which measures the resistance value of the heat resistor 302.

In this way, in a case where the prediction resistance value and the measured resistance value in each heat resistor 302 are obtained, the process proceeds to S916, and the ASIC 802 determines whether deterioration arises in each heat resistor 302 by using the prediction resistance value and the measured resistance value. Specifically, in S916, whether the ratio of a difference between a prediction resistance value Rp and a measured resistance value μm to the prediction resistance value Rp is a second threshold value Th2 or more, that is, (Rp−Rm)/Rp≥Th2 is determined. The second threshold value Th2 is the lower limit value of the ratio such that defective ejection of the ink may arise in the nozzle 204 corresponding to the heat resistor 302 or a value lower than the lower limit value by a predetermined amount. In the present embodiment, the second threshold value Th2 is 0.35%. In other words, in the present embodiment, it is determined in S916 that deterioration arises in the heat resistor 302 which satisfies (Rp−Rm)/Rp≥0.35%, and it is determined that deterioration does not arise in the heat resistor 302 which satisfies (Rp−Rm)/Rp<0.35%. In this way, in the present embodiment, the ASIC 802 (resistance value determination part 830) functions as a determination part which determines based on the prediction resistance value and the measured resistance value whether deterioration arises in the heat resistor 302.

In a case where it is determined in S916 that the heat resistor 302 in which deterioration arises exists, the process proceeds to S918, and the determination process ends in such a way that the ASIC 802 regulates the driving of the heat resistor 302 which is determined to be deteriorated, that is, regulates the application of the head voltage V. Further, in a case where it is determined in S916 that the heat resistor 302 in which deterioration arises does not exist, the determination process ends. In the present embodiment, the ASIC 802 (resistance value determination part 830) functions as a regulation part which regulates the application of a pulse voltage to the heat resistor 302 which is determined to be deteriorated.

### Modification Example

In the above descriptions, the second threshold value Th2 is a value corresponding to the value such that the defective ejection of the ink arises in the corresponding nozzle 204 but is not limited to this. For example, the second threshold value Th2 may be a value corresponding to a value such that performance on ink ejection in the corresponding nozzle 204 is degraded. In this case, in S918, the performance on the ink ejection from the nozzle 204 may be improved by adjusting, for example, the ejection energy to be applied to the heat resistor 302 determined to be deteriorated. “Performance on ink ejection is degraded” means that the performance on the ink ejection is deteriorated to the extent that the performance on the ink ejection can be improved by adjusting the ejection energy to the heat resistor, that is, changing the head voltage and the pulse width or the like.

In the above descriptions, at the timing at which the printing process ends, the deterioration of the heat resistor 302 is determined in a process subsequent to S908, but the present disclosure is not limited to this. For example, the deterioration of the heat resistor 302 may be determined by performing a process subsequent to S908 at a timing at which the number of printed sheets during the printing process reaches the predetermined number of printed sheets or at a timing at which a predetermined time passes after the start of the printing process. In this case, in a case where the heat resistor 302 which is deteriorated does not exist, the printing is resumed, and in a case where the heat resistor 302 which is deteriorated exists, the ejection of the ink from the nozzle 204 corresponding to the heat resistor 302 which is deteriorated is regulated. Furthermore, for example, the ejection of the ink from a nozzle 204 near the nozzle 204 whose ejection of the ink is regulated is adjusted by adjusting the driving data.

In the above descriptions, the prediction resistance value calculation part 828 provided in the ASIC 802 is configured to calculate the prediction resistance value, but the present disclosure is not limited to this. For example, prediction resistance values for combinations of values which material unique values (film thickness T and size [W, L]), driving setting values (head voltage V and pulse width Pw), the number of pulses, and the initial setting value R₀ may take on may be calculated in advance and may be stored in the storage area of the ROM 812.

In the above descriptions, the pulse width Pw is a fixed value, but the pulse width Pw may fluctuate according to a double pulse and a single pulse and may change according to the number of nozzles which simultaneously perform ejection and the type of ejections (for example, preliminary ejection). In that case, it is recommended to use cumulative ejection energy J in the horizontal axis to express the fluctuation and the change of the pulse width Pw.

In the above descriptions, whether the heat resistor is deteriorated is determined based on the ratio of the difference between the prediction resistance value and the measured resistance value to the prediction resistance value, but the configuration is not limited to this. For example, a resistance value and a prediction resistance value measured after the printing process are held. Further, in a case of a determination process, it is determined that the heat resistor is deteriorated in a case where the fluctuation amount of a resistance value measured after a current printing process from a measured resistance value after a previous printing process is higher than the fluctuation amount of a prediction resistance value after the current printing process from a prediction resistance value after the previous printing process.

Incidentally, the described techniques in the first embodiment and the techniques described as the modification examples of various types may be used in combination as appropriate.

### (Operation and Effect)

As described in the above, in the printing apparatus 10 according to the present embodiment, the prediction resistance value of each heat resistor 302 is obtained based on manufacturing dispersion or errors in the heat resistor 302 and the driving setting values of the printing head 24 in which a load on the heater resistor 302 arises. Further, it is determined that the deterioration arises in the heat resistor 302 in a case where the ratio of a difference between the prediction resistance value and the resistance value which is actually measured to the prediction resistance value is a threshold value or more. The deterioration of the heat resistor 302 can be thereby determined according to manufacturing dispersion or errors in the heat resistor 302 and the driving setting values of the printing head 24, and the deterioration of the heat resistor 302 can be correctly determined.

### Second Embodiment

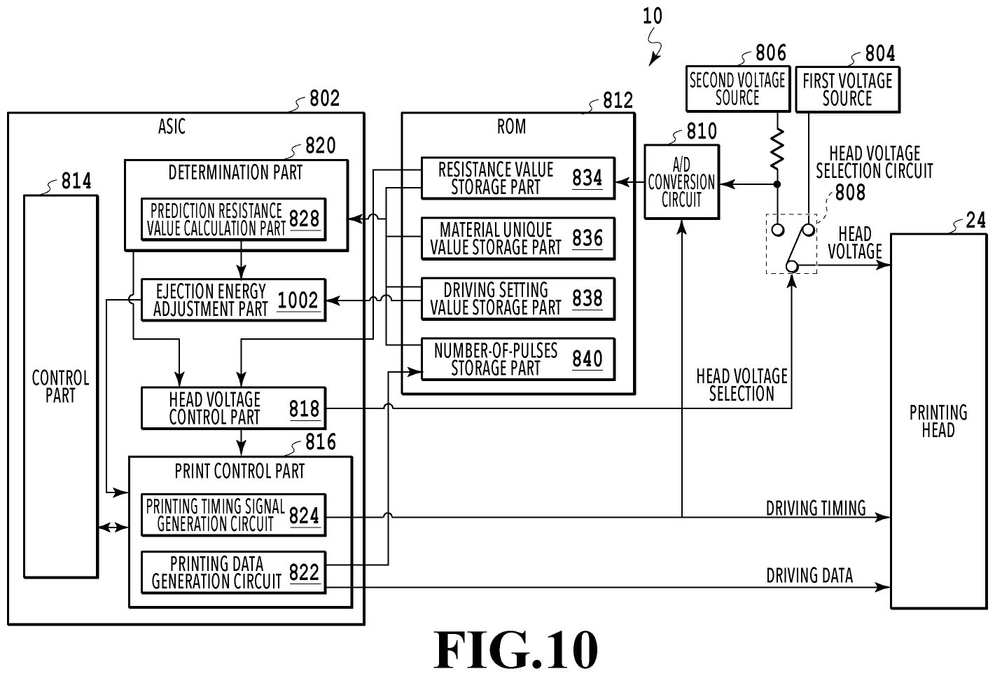

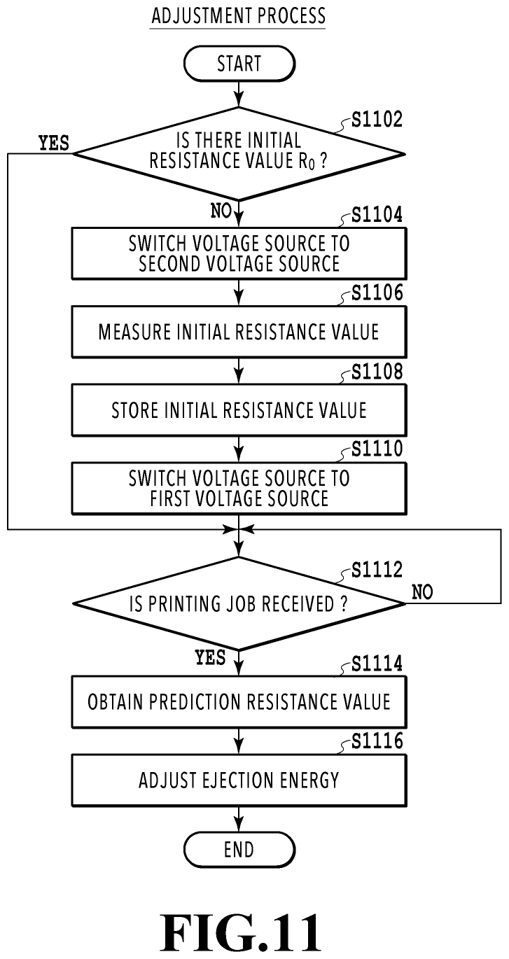

Next, with reference to FIG. 10 and FIG. 11, a printing apparatus according to a second embodiment is described. In the following descriptions, in regard to elements identical or corresponding to those in the printing apparatus according to the first embodiment mentioned above, the details of the elements are omitted by using reference signs identical to those used in the first embodiment.

The second embodiment is different from the first embodiment mentioned above in that ejection energy to be applied to a heat resistor is adjusted by using a prediction resistance value and a measured resistance value of the heat resistor. Details are described below.

### <Configuration of Control System of Printing Apparatus>

First, the configuration of a control system of the printing apparatus according to the present embodiment is described. FIG. 10 is a block diagram illustrating the configuration of the control system of the printing apparatus according to the present embodiment. Incidentally, in FIG. 10, for the sake of easy understanding, the illustrations of the resistance value determination part 830 and the number-of-pulses determination part 826 in the determination part 820 are omitted.

The printing apparatus 10 according to the present embodiment is different from the printing apparatus described in the first embodiment mentioned above in that the cjection energy adjustment part 1002 is added to the ASIC 802. Thus, in the following descriptions, differences of the printing apparatus according to the second embodiment from the printing apparatus according to the first embodiment are described, and the details of the same elements are omitted.

The printing apparatus 10 according to the present embodiment includes the ejection energy adjustment part 1002 in the ASIC 802. The ejection energy adjustment part 1002 adjusts the ejection energy J by adjusting the pulse width Pw based on the head voltage V and required ejection energy Js stored in the material unique value storage part 836 and a prediction resistance value calculated in the prediction resistance value calculation part 828 in a predetermined heat resistor.

Further, in the printing apparatus 10 according to the present embodiment, the required ejection energy Js is further stored in the driving setting value storage part 838. In the present embodiment, the required ejection energy Js is, for example, minimum ejection energy required to maintain ejection performance at a predetermined level.

### <Adjustment Process>

In the present embodiment, for example, at a timing before a printing process is performed such as a timing at which the printing apparatus 10 is activated, an adjustment process for adjusting the ejection energy to be applied to each heat resistor 302 is performed. FIG. 11 is a flow chart illustrating the details of processing of the adjustment process to adjust the ejection energy to be applied to each heat resistor 302. A series of processes illustrated in the flow chart of FIG. 11 is performed as a result of the ASIC 802 developing a program code stored in the ROM 812 into a RAM (not illustrated) and executing the program code. Alternatively, the functions of part of or all of the steps in FIG. 11 may be performed by hardware such as other ASICs or electric circuits.

Here, a calculation formula used for the adjustment process is described. In the adjustment process in the present embodiment, the adjustment of the ejection energy is performed by adjusting the pulse width Pw in such a way that the ejection energy is equal to the required ejection energy Js. Thus, the following formula (6) is obtained by replacing the ejection energy J with the required ejection energy Js in the formula (3) mentioned above and substituting the required ejection energy Js into the formula (5) mentioned above.

$$\frac{Δ R}{{R}_{0}} = ( \frac{{DR}_{0} TW}{L} + {( \frac{A}{T} )}^{N} ) ( 1 - exp ( - {P}_{c}^{\frac{1}{- {B}_{1} {J}_{s} + {B}_{2}}} ) ) - \frac{{DR}_{0} TW}{L} ( 1 - exp ( - {P}_{c}^{\frac{1}{- {E}_{1} {J}_{s} + {E}_{2}}} ) ) \qquad ( 6 )$$

Incidentally, the required ejection energy Js is a constant value. The prediction resistance value of the heat resistor 302 in a case of the predetermined number of pulses Pc can be calculated by substituting the film thickness T and the size (W, L), the initial resistance value R₀, the head voltage V, the required ejection energy Js, and the number of pulses Pc of the heat resistor 302 into the formula (6) mentioned above.

In a case where the adjustment process starts, first, in S1102, the ASIC 802 determines whether the initial resistance value R₀ exists in each heat resistor 302. Specifically, in S1102, whether the initial resistance value R₀ of each heat resistor 302 is stored is determined in the resistance value storage part 834.

In a case where it is determined in S1102 that the initial resistance value R₀ of each heat resistor 302 exists, the process proceeds to S1112 described later. Further, in a case where it is determined in S1102 that the initial resistance value R₀ of each heat resistor 302 does not exist, in S1104, a voltage source from which the ASIC 802 supplies a voltage to the printing head 24 is the second voltage source 806. Further, in S1106, the ASIC 802 measures the initial resistance value R₀ of each heat resistor 302. Subsequently, in S1108, the ASIC 802 stores the measured initial resistance value R₀ in the resistance value storage part 834. Furthermore, in S1110, a voltage source from which the ASIC 802 supplies a voltage to the printing head 24 is the first voltage source 804.

Next, in S1112, the ASIC 802 determines whether the printing job is received or not. In a case where it is determined in S1112 that the printing job is received, the process proceeds to S1114, and the ASIC 802 obtains the prediction resistance value of each heat resistor 302. Specifically, in S1114, first, the initial resistance value R₀, the film thickness T and the size (W, L), the head voltage V, the required ejection energy Js, and the cumulative number of pulses Pc of each heat resistor 302 are obtained. The initial resistance value R₀ is stored in the resistance value storage part 834. The film thickness T and the size (W, L) are stored in the material unique value storage part 836. The head voltage V and the required ejection energy Js are stored in the driving setting value storage part 838. The cumulative number of pulses Pc is stored in the number-of-pulses storage part 840. These obtained values are substituted into the formula (6) mentioned above, and the prediction resistance value of each heat resistor 302 is obtained.

Subsequently, in S1116, the ASIC 802 adjusts the ejection energy to be applied to each heat resistor 302. Specifically, in S1114, the obtained prediction resistance value, the head voltage V, and the required ejection energy Js are substituted in the formula (3) mentioned above, and the pulse width Pw is adjusted in such a way that the ejection energy J is the required ejection energy Js, and this adjustment process is ended. In this way, in the present embodiment, the ASIC 802 (ejection energy adjustment part 1002) functions as an adjustment part which adjusts the pulse width of a pulse voltage to be applied to the heat resistor 302.

Further, in the printing process based on the printing job, the pulse width Pw after the adjustment is used. Incidentally, in the printing apparatus 10, a determination process is performed in parallel with the printing process. Thus, in the printing apparatus 10 according to the present embodiment, ejection energy is adjusted to become ejection energy suitable for the heat resistor 302 before the printing process, and then the printing process is performed by using the adjusted ejection energy, and subsequently the deterioration of the heat resistor 302 is detected.

### Modification Example

In the above descriptions, as ejection energy adjustment, the pulse width Pw in a case where the head voltage V is applied to the heat resistor 302 is adjusted, but the present disclosure is not limited to this. For example, the head voltage V may be adjusted.

Although not particularly described in the above descriptions, for example, the heat resistor determined to be a target of adjustment by the determination process described in the first embodiment mentioned above may be adjusted. In this case, in the determination process, whether the heat resistor is deteriorated to the extent that the performance on the ink ejection from the corresponding nozzle is degraded is determined. Incidentally, “performance on ink ejection is degraded” means that the heat resistor is deteriorated to the extent that ejection performance cannot be maintained at a predetermined level.

Specifically, the first threshold value Th1 is, for example, the lower limit value of the number of pulses Pc in which the performance on the ink ejection can be degraded in the corresponding nozzle by the heat resistor 302 or a value lower than the lower limit value by a predetermined amount. In S908, the heat resistor 302 which is a target of determination is thereby extracted. Further, the second threshold value Th2 is, for example, the lower limit value of a value such that the performance on the ink ejection can be degraded in a nozzle corresponding to the heat resistor or a value lower than the lower limit value by a predetermined amount. In 916, the heat resistor which is deteriorated to the extent that the ejection energy has to be adjusted is thereby extracted to maintain an ink ejection performance.

Furthermore, the heat resistor which is determined to be deteriorated in S918 is a heat resistor which is a target of adjustment. Subsequently, in the adjustment process, the ASIC 802 adjusts the ejection energy to be applied to the heat resistor which is the target of adjustment. Specifically, the processes in S1114 and S1116 are performed. The adjusted pulse width Pw is associated with the heat resistor 302, stored in the driving setting value storage part 838, and used for a printing process based on a next printing job

Incidentally, the techniques described in the first embodiment and the techniques described as the modification examples of various types mentioned above may be used in combination as appropriate.

### <Operation and Effects>

As described above, in the printing apparatus 10 according to the present embodiment, the prediction resistance value of each heat resistor 302 is obtained based on the driving setting values of the printing head 24 in which manufacturing dispersion or errors in the heat resistor 302 and a load on the heat resistor 302 arise. Further, the ejection energy to be applied to the heat resistor 302 is adjusted by adjusting the pulse width Pw by using the prediction resistance value, the head voltage V, and the required ejection energy Js. The ejection energy of the heat resistor 302 can be thereby adjusted according to manufacturing dispersion or errors in the heat resistor 302 and the driving setting values of the printing head, and suitable adjusted energy can be applied to the heat resistor.

### Third Embodiment

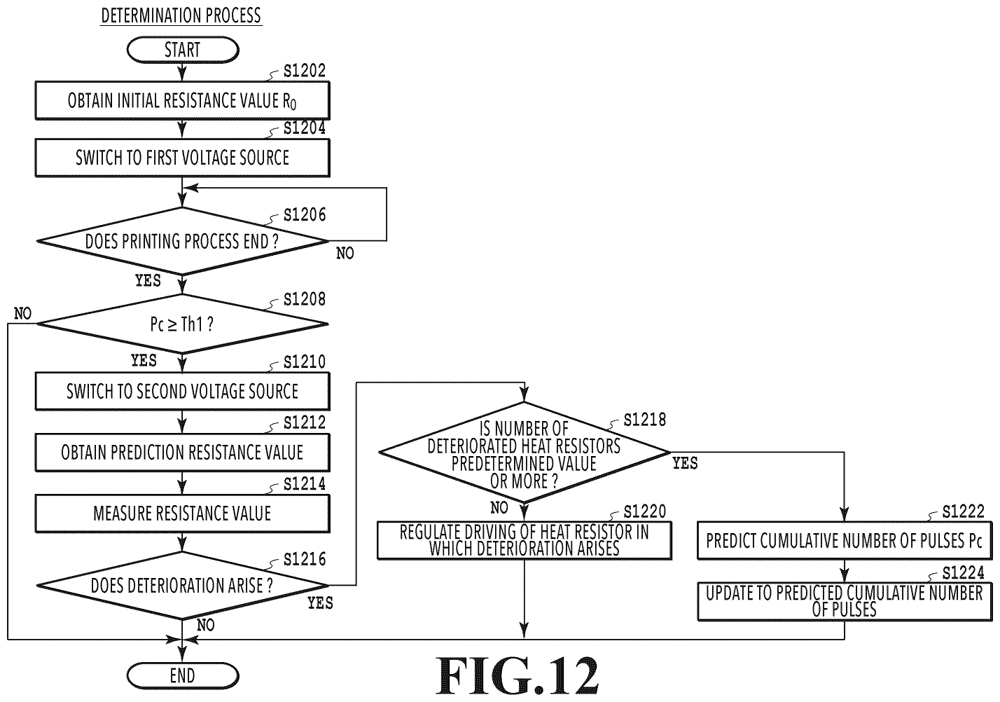

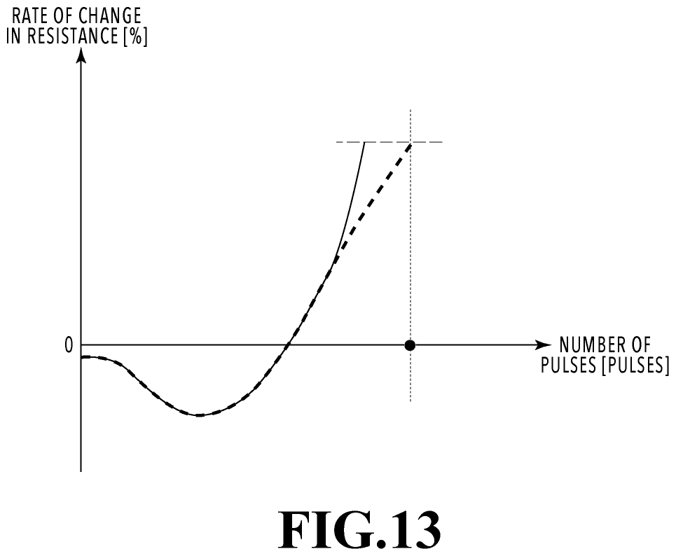

Next, with reference to FIG. 12 and FIG. 13, a printing apparatus according to a third embodiment is described. In the following descriptions, in regard to elements identical or corresponding to those in the printing apparatus according to the first embodiment mentioned above, the details of the elements are omitted by using the same reference signs as those used in the first embodiment.

In a case where the printing apparatus 10 is left for a long period, the oxidization of the heat resistor 302 progresses, and the resistance value of the heat resistor 302 which is actually measured may deviate from a prediction resistance value. In this case, even though the heat resistor 302 is not deteriorated, it may be determined that deterioration arises in the heat resistor 302. Then, the third embodiment centers on the number of the heat resistors 302 which are determined to be deteriorated in the printing head 24, deterioration of the heat resistor 302 does not arise in a case where the number of the heat resistors is a predetermined value or more, and the cumulative number of pulses is adjusted based on a prediction curve. Details are described below.

### <Determination Process>

FIG. 12 is a flow chart illustrating the details of processing of a determination process performed in a printing apparatus according to the present embodiment. A series of processes illustrated in the flow chart of FIG. 12 is performed as a result of the ASIC 802 developing a program code stored in the ROM 812 into a RAM (not illustrated) and executing the program code. Alternatively, the functions of part of or all of the steps in FIG. 12 may be performed by hardware such as other ASICs or electrical circuits.

In a case where the determination process starts, first, in S1202, the ASIC 802 obtains the initial resistance value R₀. Next, in S1204, the ASIC 802 switches a voltage source into the first voltage source 804. Further, in S1206, the ASIC 802 determines whether a printing process ends. In the present embodiment, the printing process is started after the end of the process in S1204. In a case where it is determined in S1206 that the printing process ends, the process proceeds to S1208, and the ASIC 802 determines whether the number of pulses Pc applied to the heat resistor 302 reaches the first threshold value Th1.

In a case where it is determined in S1208 that the number of pulses Pc does not reach the first threshold value Th1, the process proceeds to S1210, and the ASIC 802 switches a voltage source into the second voltage source. Next, in S1212, the ASIC 802 obtains the prediction resistance value of each heat resistor 302. Further, in S1214, the ASIC 802 measures the resistance value of each heat resistor 302. Furthermore, the ASIC 802 determines whether deterioration arises in each heat resistor 302 in S1216 by using the prediction resistance value and the measured resistance value. Incidentally, the specific details of processing of S1202 to 1216 are the same as those of S902 to S916 mentioned above and the detailed descriptions of the processing are omitted.

In case where it is determined in S1216 that the heat resistor 302 in which deterioration arises does not exist, the determination process ends. Further, in a case where it is determined in S1216 that the heat resistor 302 in which deterioration arises exists, the process proceeds to S1218, and the ASIC 802 determines whether the number of the heat resistors 302 in which the deterioration arises is a predetermined value or more. The predetermined value is, for example, 20% of the total number of nozzles 204 in the printing head 24. Incidentally, the predetermined value may be changeable as appropriate. Furthermore, the predetermined value is experimentally determined according to, for example, the material for the heat resistor 302, environment temperature, and time for which the printing apparatus 10 is left

In a case where it is determined in S1218 that the number of the heat resistors 302 in which the deterioration arises is less than the predetermined value, the process proceeds to S1220, and the ASIC 802 regulates the driving of the heat resistor 302 in which the deterioration arises, and the determination process ends. Further, in case where it is determined in S1218 that the number of the heat resistors 302 in which the deterioration arises is the predetermined value or more, the process proceeds to S1222, and the ASIC 802 predicts the adequate cumulative number of pulses Pc in the heat resistor 302. Further, in S1224, the ASIC 802 updates the cumulative number of pulses Pc stored in the number-of-pulses storage part 840 to the cumulative number of pulses Pc predicted in S1222, and the determination process ends. In the present embodiment, the ASIC 802 (control part 814) functions as a prediction part which predicts the cumulative number of pulses of the heat resistor 302 which is determined to be deteriorated and functions as an update part updating the number of pulses Pc stored in the number-of-pulses storage part 840.

As mentioned above, in a case where the printing apparatus 10 is left for a long period, the oxidization of the heat resistor 302 progresses, and the measured resistant value of the heat resistor 302 sharply deviates from the prediction resistance value. In this case, it is determined that the heat resistor 302 is deteriorated even though the heat resistor 302 is not deteriorated. In a case where the measured resistance value sharply deviates from the prediction resistance value due to oxidation of the heat resistor 302 and the like, it is determined that a similar phenomenon arises in a relatively large number of the heat resistors 302 and the deterioration occurs.

Thus, in the present embodiment, in a case where it is determined in S1218 that the number of the heat resistors 302 which are deteriorated is the predetermined value or more, it is determined that the measured resistance values do not result from the deterioration of the heat resistors. Further, in S1222, the cumulative number of pulses Pc in the heat resistors 302 in which the deterioration arises is predicted. Furthermore, in S1224, the cumulative number of pulses Pc of the heat resistors stored in the number-of-pulses storage part 840 is updated to the cumulative number of pulses Pc which is predicted. The cumulative number of pulses Pc stored in the number-of-pulses storage part 840 thereby becomes approximate to a value according to the deterioration of the heat resistors.

Specifically, in S1222, in regard to each heat resistor 302 in which the deterioration arises, a graph shown in FIG. 13 illustrating the relation between a change curve (solid line curve) of the actual value of a resistance value and a change curve (broken line curve) of a prediction resistance value is used in the determination part 820. In more detail, in regard to each heat resistor 302 in which the deterioration arises, with reference to the rate of change in resistance based on the prediction resistance value corresponding to the rate of change in resistance based on the measured resistance value, the number of pulses in a case of the rate of change in resistance based on the prediction resistance value is obtained as the predicted cumulative number of pulses Pc.

### Modification Example

Although not particularly described in the above descriptions, a notification promoting a user to replace the printing head 24 may be provided according to the number of the heat resistors 302 in which cumulative deterioration caused by performing the determination process several times (that is, the printing process is performed several times) arises. In this case, for example, the notification may be provided via an operation panel or the like provided in the printing apparatus 10 or via a host computer or the like connected to the printing apparatus 10.

In the above descriptions, it is determined based on the number of the heat resistors 302 which are determined to be deteriorated that the measured resistance value does not result from the deterioration of the heat resistors, but the present disclosure is not limited to this. For example, a configuration which can count a time by using electric power from a battery even in case where the printing apparatus 10 is turned off is made. Further, in the ASIC 802, an elapsed time from a previous printing process to a current printing process is measured, and it may be determined based on the elapsed time that the measured resistance values do not result from the deterioration of the heat resistors. In this case, the ASIC 802 (control part 814) functions as a time measurement part which measures the elapsed time from the previous printing process to the current printing process.

Specifically, in a case where it is determined in S1216 that the heat resistor in which the deterioration arises exists, an elapsed time from an immediate printing process performed by the printing apparatus 10 to this printing process is calculated, and in a case where the elapsed time is a predetermined time or more, the process proceeds to S1222. Incidentally, in regard to a method for obtaining the elapsed time, the elapsed time may be obtained from, for example, an external apparatus connected to a network, not by using a battery or the like.

Incidentally, the techniques described in the first embodiment and the techniques described as the modification examples of various types may be used in combination as appropriate.

### <Operation and Effect>

As described above, in the printing apparatus 10 according to the present embodiment, the prediction resistance value of each heat resistor 302 is obtained based on the manufacturing dispersion or errors in the heat resistor 302 and the driving setting values of the printing head 24 in which a load on the heat resistor 302 arises. Further, the deterioration of the heat resistor is determined based on the ratio of the difference between the prediction resistance value and the actual resistance value to the prediction resistance value. Furthermore, it is determined that the measured resistance value is not ascribed to the deterioration of the heat resistor according to the number of the heat resistors which are determined to be deteriorated, and the value of the cumulative number of pulses stored in the number-of-pulses storage part is changed to the value of the predicted cumulative number of pulses.

In addition to the operation and effect of the first embodiment mentioned above, an erroneous determination caused by leaving the printing apparatus 10 for a long period can be thereby detected, and it is possible to detect the deterioration of the heat resistor more accurately.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to detect the deterioration of the heat resistor accurately.

This application claims the benefit of Japanese Patent Application No. 2024-156738, filed Sep. 10, 2024, which is hereby incorporated by reference herein in its entirety.

What is claimed is:

1. A printing apparatus comprising:
a printing head configured to eject an ink from a nozzle provided so that the nozzle corresponds to a heat resistor and perform printing by applying a pulse voltage to the heat resistor;
an obtaining unit configured to obtain a prediction resistance value of the heat resistor according to a unique value of the heat resistor and a setting value to drive the heat resistor;
a measurement unit configured to measure a resistance value of the heat resistor; and
a determination unit configured to determine based on the prediction resistance value and the resistance value whether deterioration arises in the heat resistor.

2. The printing apparatus according to claim 1, further comprising
a regulation unit configured to regulate application of the pulse voltage to the heat resistor determined to be deteriorated by the determination unit.

3. The printing apparatus according to claim 1, wherein
the unique value of the heat resistor includes a film thickness and a size of the heat resistor.

4. The printing apparatus according to claim 1, wherein
the setting value to drive the heat resistor includes a pulse width and a voltage value of the pulse voltage.

5. The printing apparatus according to claim 1, further comprising:
a first voltage source configured to apply a pulse voltage to the heat resistor at a predetermined voltage value;
a second voltage source configured to apply a pulse voltage to the heat resistor at a voltage value lower than the predetermined voltage value; and
a connection unit configured to selectively connect the first voltage source and the second voltage source to the heat resistor; wherein
the connection unit connects the heat resistor to the first voltage source in a case where printing is performed by the printing head, and
the connection unit connects the heat resistor to the second voltage source in a case where the resistance value is measured.

6. The printing apparatus according to claim 1, wherein
the determination unit determines that the deterioration arises in the heat resistor in a case where a ratio of a difference between the prediction resistance value and the resistance value to the prediction resistance value is a threshold value or more.

7. The printing apparatus according to claim 1, further comprising
a storage unit configured to store the resistance value and the prediction resistance value; wherein
the determination unit determines that the deterioration arises in the heat resistor in a case where a fluctuation amount of the resistance value in a current printing process from the resistance value in a previous printing process exceeds a fluctuation amount of the prediction resistance value in the current printing process from the prediction resistance value in the previous printing process.

8. The printing apparatus according to claim 1, wherein
the obtaining unit uses an initial resistance value and a number of pulses of the heat resistor in a case where the prediction resistance value is obtained.

9. The printing apparatus according to claim 8, wherein
the initial resistance value is a resistance value obtained by making measurement on the heat resistor in a case where the number of pulses is less than 100.

10. The printing apparatus according to claim 1, further comprising
an adjustment unit configured to adjust a voltage value or a pulse width of the pulse voltage based on the prediction resistance value.

11. The printing apparatus according to claim 1, further comprising:
a storage unit configured to store a cumulative number of pulses of the heat resistor based on data to control the printing head;
a prediction unit configured to predict the cumulative number of pulses of the heat resistor in a case where a number of the heat resistors which are determined to be deteriorated by the determination unit is a predetermined value or more; and
an update unit configured to update the cumulative number of pulses stored in the storage unit to the number of pulses predicted by the prediction unit.

12. The printing apparatus according to claim 1, further comprising:
a storage unit configured to store a cumulative number of pulses of the heat resistor based on data to control the printing head;
a prediction unit configured to predict the cumulative number of pulses of the heat resistor determined to be deteriorated by the determination unit in a case where an elapsed time from a previous printing process to a current printing process is a predetermined time or more; and
an update unit configured to update a number of pulses stored in the storage unit to a number of pulses measured by the prediction unit.

13. The printing apparatus according to claim 12, further comprising
a time measurement unit configured to measure the elapsed time.

14. The printing apparatus according to claim 12, wherein
the elapsed time is obtained from an external apparatus connected to a network.

15. The printing apparatus according to claim 11, wherein
the prediction unit predicts the cumulative number of pulses from relation between a change curve illustrating a rate of change in resistance according to the number of pulses of the resistance value measured by the heat resistor and a change curve illustrating a rate of change in resistance according to the number of pulses of the prediction resistance value of the heat resistor.

16. A control method for controlling a printing apparatus comprising a printing head configured to eject an ink from a nozzle provided so that the nozzle corresponds to a heat resistor and perform printing by applying a pulse voltage to the heat resistor, the control method comprising:
obtaining a prediction resistance value of the heat resistor according to a unique value of the heat resistor and a setting value to drive the heat resistor;
measuring a resistance value of the heat resistor; and
determining based on the prediction resistance value and the resistance value whether deterioration arises in the heat resistor.

17. The control method according to claim 16, wherein
the obtaining, the measuring, and the determining are performed in a case where a cumulative number of pulses to the heat resistor is a predetermined threshold or more after a process including an operation performed by the driving of the heat resistor.

18. The control method according to claim 16, further comprising
adjusting a voltage value or a pulse width of the pulse voltage based on the prediction resistance value.

19. The control method according to claim 18, wherein
before a printing process performed by the printing head, the voltage value or the pulse width of the pulse voltage in the printing process is adjusted by the adjusting.

20. The control method according to claim 16, further comprising:
predicting a cumulative number of pulses of the heat resistor in a case where a number of the heat resistors determined to be deteriorated in the determining is a predetermined value or more; and
updating a number of pulses which is stored in a storage unit configured to store the cumulative number of pulses of the heat resistor based on data to control the printing head to the number of pulses predicted in the predicting.

21. The control method according to claim 16, further comprising:
predicting a cumulative number of pulses of the heat resistor determined to be deteriorated by the determining in a case where an elapsed time from a previous printing process to a current printing process is a predetermined time or more; and
updating to a number of pulses which is stored in a storage unit configured to store the cumulative number of pulses of the heat resistor based on data to control the printing head to the number of pulses predicted in the predicting.

22. A non-transitory computer readable storage medium storing a program for causing a computer to perform a control method for controlling a printing apparatus comprising a printing head configured to eject an ink from a nozzle provided so that the nozzle corresponds to a heat resistor and perform printing by applying a pulse voltage to the heat resistor, the control method comprising:
obtaining a prediction resistance value of the heat resistor according to a unique value of the heat resistor and a setting value to drive the heat resistor;
measuring a resistance value of the heat resistor; and
determining based on the prediction resistance value and the resistance value whether deterioration arises in the heat resistor.
